(19) United States
(12) Patent Application Publication
(10) Pub. No.: US 2007/0090096 A1
(43) Pub. Date: Apr. 26, 2007

(54) Welding device

(76) Inventor: Gerhard Lechler, Berlin (DE)

Correspondence Address: Mark P. Stone, 25 Third Street, 4th Floor, Stamford, CT, 06905, US

(21) Appl. No.: 10/583,193

(22) PCT Filed: Dec. 15, 2004
(86) PCT No.: PCT/EP04/14513

§ 371 Date: Jun. 14, 2006

(30) Foreign Application Priority Data
Dec. 18, 2003 (DE) 103 60 313.1

(51) Int. Cl. B23K 11/10

(52) U.S. Cl. 219/86.32

(57) ABSTRACT

The invention relates to a welding device comprising electrode carriers (6, 12) which are actuated by a servomotor (9). The inventive welding device is characterized in that the servomotor (9) and the electrode carriers (6, 12) constitute a unit that is floatingly mounted on a linear guide (1) and that is maintained in a base position by means of equilibration elements (21).

### FIELD OF THE INVENTION

The invention relates to a welding apparatus with two electrode carriers which can be moved relative to one another by a servomotor and can be mounted with electrodes.

### BACKGROUND OF THE INVENTION

Welding apparatuses of the above type, in which a scissor-like movement is executed either—as in the case of DE 101 44 731 A1—by both electrode carriers or—as in the case of DE 33 27 510 C2—by at least one electrode carrier are known.

In both known apparatuses, which are also described as welding tongs, at least one electrode moves on a circular path. This means that for example when welding metal sheets of different thicknesses, there is no guarantee of contact surfaces between the metal sheets and the electrodes remaining constant. If the pivoting movement into the electrode carriers—as in the case of DE 101 44 731 A1—is moreover introduced into those ends of the electrode carriers which are remote from the electrodes by spindles driven by a common electric motor, bending loads in the spindles, which promote wear to the spindle mechanisms, is likely. A further drawback of the known designs is the fact that whenever the distance between the electrodes, which have been moved into the welding position, and the weld metal before the electrodes are pressed on differs, it is impossible to rule out the possibility of deformation to the weld metal, since the electrode located closer to the weld metal displaces the weld metal toward the electrode located further from the weld metal. The distances covered are in practice small but by no means insignificant for a perfect welding process.

### SUMMARY OF THE INVENTION

The invention is based on the object of providing a welding apparatus of the type under consideration in which the two electrodes execute a linear movement and in which positioning errors when the electrodes are being moved into the welding position are compensated for without disruptive displacement or deformation of the weld metal. In a welding apparatus of the type under consideration, this object is achieved, according to the invention, by the fact that it has at least one linear guide, on which both electrode carriers are guided, that the electrode carriers and the servomotor form an assembly mounted in a floating position on the linear guide, and that the assembly is held in a base position, from which the electrode carriers can be transferred to the welding position, by means for compensating for its weight.

The welding apparatus according to the invention offers the advantage that, on account of the linear movement of the electrode carriers, complete, flush contact between the electrodes and the weld metal is ensured irrespective of the position and thickness of the parts to be welded. The floating mounting of the parts used to carry out the welding operation allows the electrodes to be automatically transferred to a symmetrical position with respect to the weld metal. The means for weight compensation, which are preferably formed by at least one spring, hold the electrode carriers and the servomotor in a central position.

It has proven particularly advantageous if the apparatus is equipped with a brake, by which the assembly formed by the electrode carriers and the servomotor can be locked on the linear guide during certain process phases.

Further features and details of the invention will emerge from the subclaims and the following description of an embodiment of the invention which is illustrated in the accompanying diagrammatic drawings.

### BRIEF DESCRIPTION OF THE DRAWINGS

In the drawings:

FIG. 1 shows the main parts of the apparatus, which has been transferred to a welding location, in its starting position,

FIG. 2 shows the position of the parts of the welding apparatus from FIG. 1 in a first intermediate position,

FIG. 3 shows the position of the parts of the welding apparatus in a second intermediate position,

FIG. 4 shows the position of the parts of the welding apparatus in the welding position, and

FIG. 5 shows the position of the parts of the welding apparatus while it is being returned to the starting position.

### WAYS OF CARRYING OUT THE INVENTION

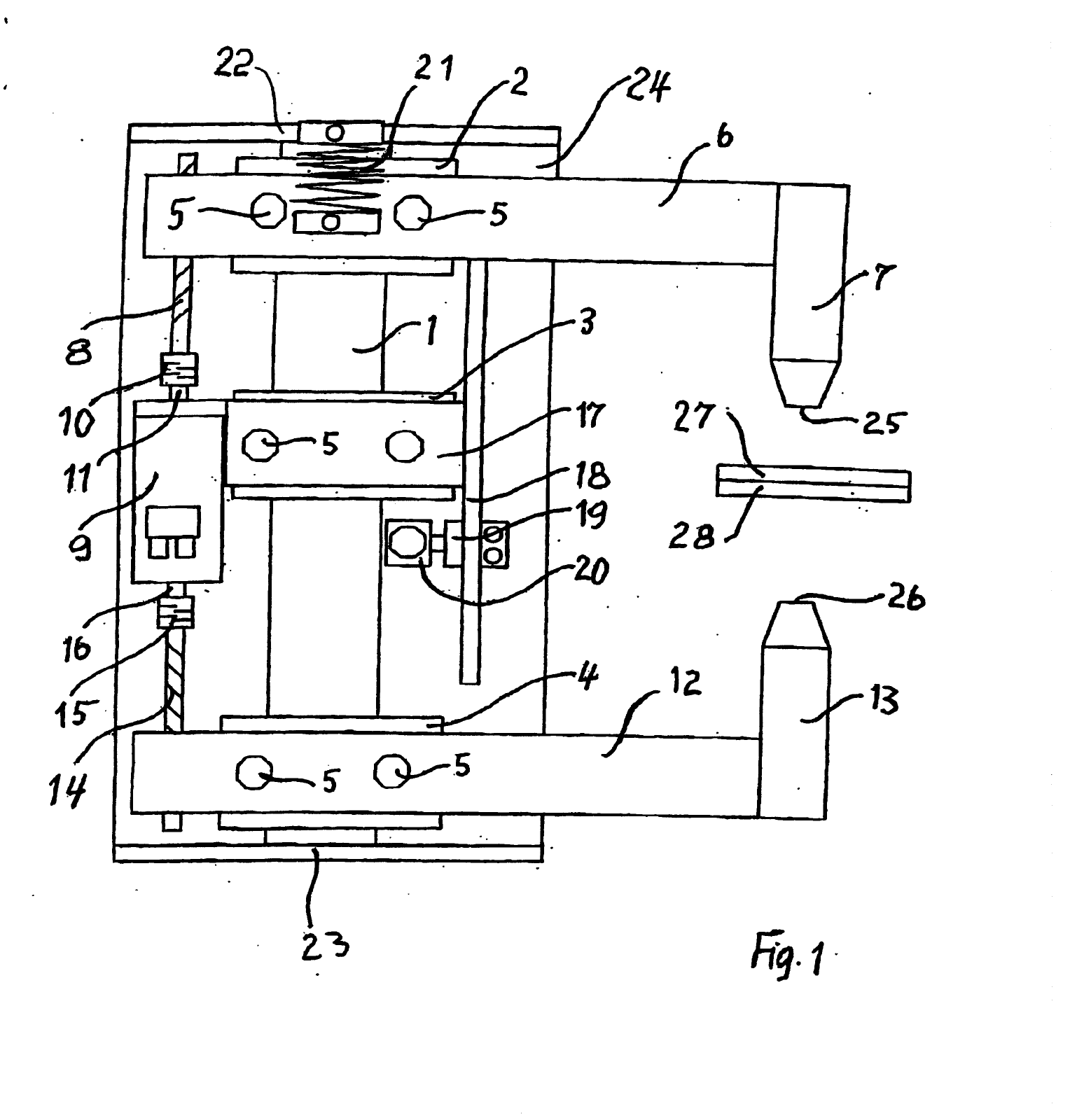

In FIG. 1, 1 denotes a linear guide, on which three carriages 2, 3 and 4 are mounted in a floating manner. An upper electrode carrier 6, which at one end carries an electrode 7 and at its other end, by means of a nut (not shown), surrounds the spindle 8 of a threaded mechanism driven by a servomotor 9, is connected to the carriage 2 by bolts 5. 10 denotes a clutch which connects the upper shaft stub 11 of the shaft of the servomotor 9 to the spindle 8.

A lower electrode carrier 12, which at one end carries an electrode 13 and at its other end, by means of a nut (not shown), surrounds a further spindle 14 of the threaded mechanism, is connected to the carriage 4 by means of bolts 5, the spindle 14 being connected to the shaft stub 16 of the shaft of the servomotor 9 by means of a clutch 15. The spindles 8 and 14 have opposing screw threads.

The servomotor 9 is connected to the carriage 3 by means of a crossbar 17. A brake rail 18, the position of which can be locked in any desired position by the brake piston 19 of an electrically or pneumatically actuable brake 20, is fixed to that end of the crossbar 17 which is remote from the servomotor 9.

The carriages 2, 3, 4 with the electrode carriers 6 and 12 and the crossbar 17 together with the servomotor 9 and the spindles 8, 14 form an assembly which is mounted in a floating position on the linear guide 1, a spring 21 with as far as possible a linear characteristic being responsible for weight compensation. As an alternative to the weight compensation by means of a spring, it is also conceivable to use a pneumatic weight compensation.

End stops 22 and 23, which together with the clutches 10 and 15, which are designed as slipping clutches, prevent the spindles 8 and 14 from rotating out of the nuts of the threaded mechanisms arranged in the electrode carriers 6, 12, are arranged at the upper and lower ends of the linear guide. Both the end stops 22, 23 and the linear guide 1 are secured to a base plate 24, via which the welding apparatus can be connected, for example, to an industrial robot.

The arrangement of the components described is deemed particularly advantageous but does not preclude modifications. For example, the linear guide 1 could be replaced by two parallel guides which are arranged at a distance from one another and between which the servomotor 9 and the spindles 8, 14 may lie. Moreover, it would be possible for the threaded mechanism to be arranged between those ends of the electrode carriers 6, 12 which hold the electrodes 7, 13, to mention just a few conceivable variants. It is in any event ensured that no bending moments are introduced into the spindles of the threaded mechanism and that the end faces 25, 26 of the electrodes 7 and 13 are oriented parallel to one another and to the weld metal.

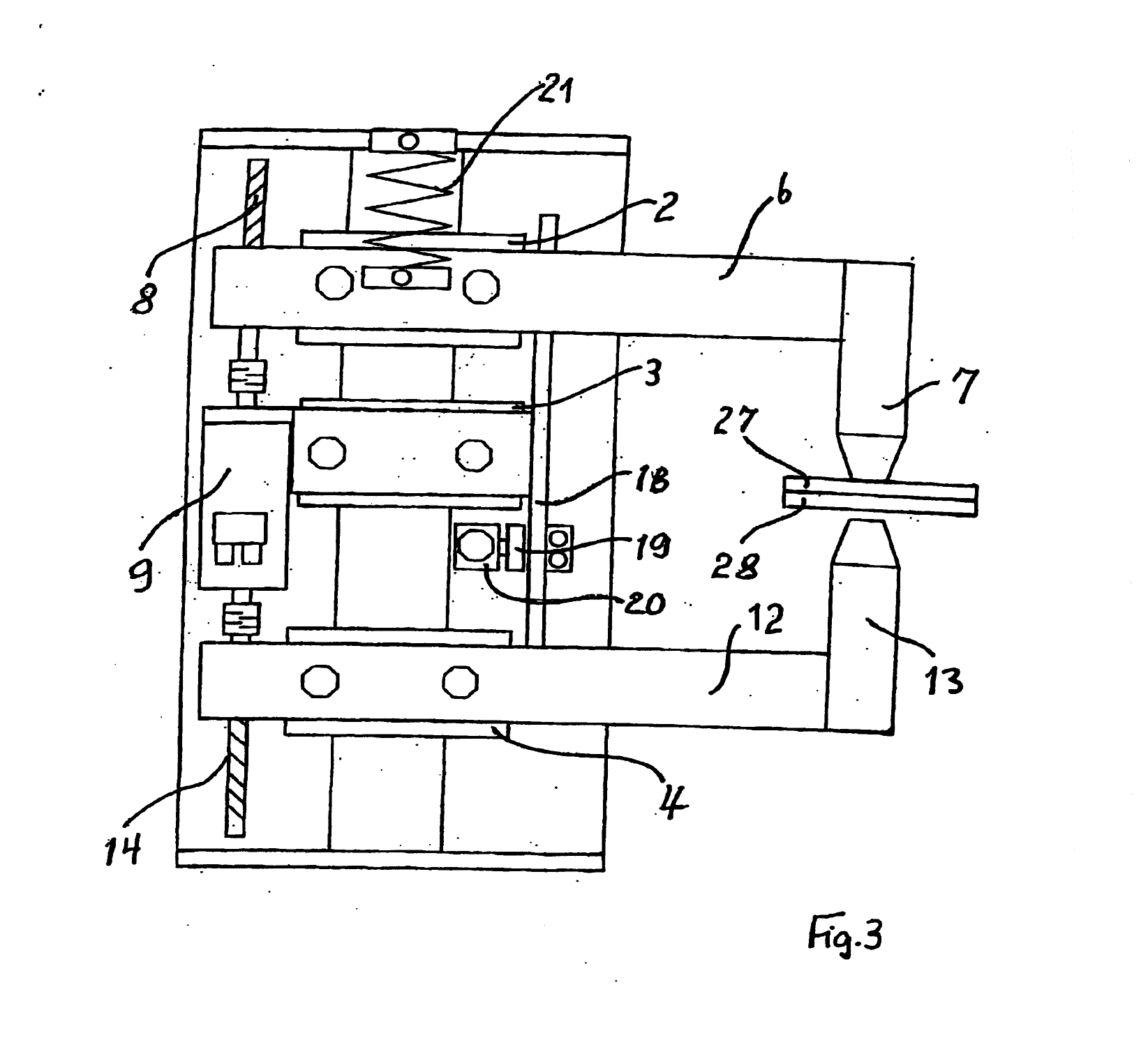

To provide an improved understanding of the state of affairs, the sequence of a welding operation will now be outlined with reference to FIGS. 1 to 5.

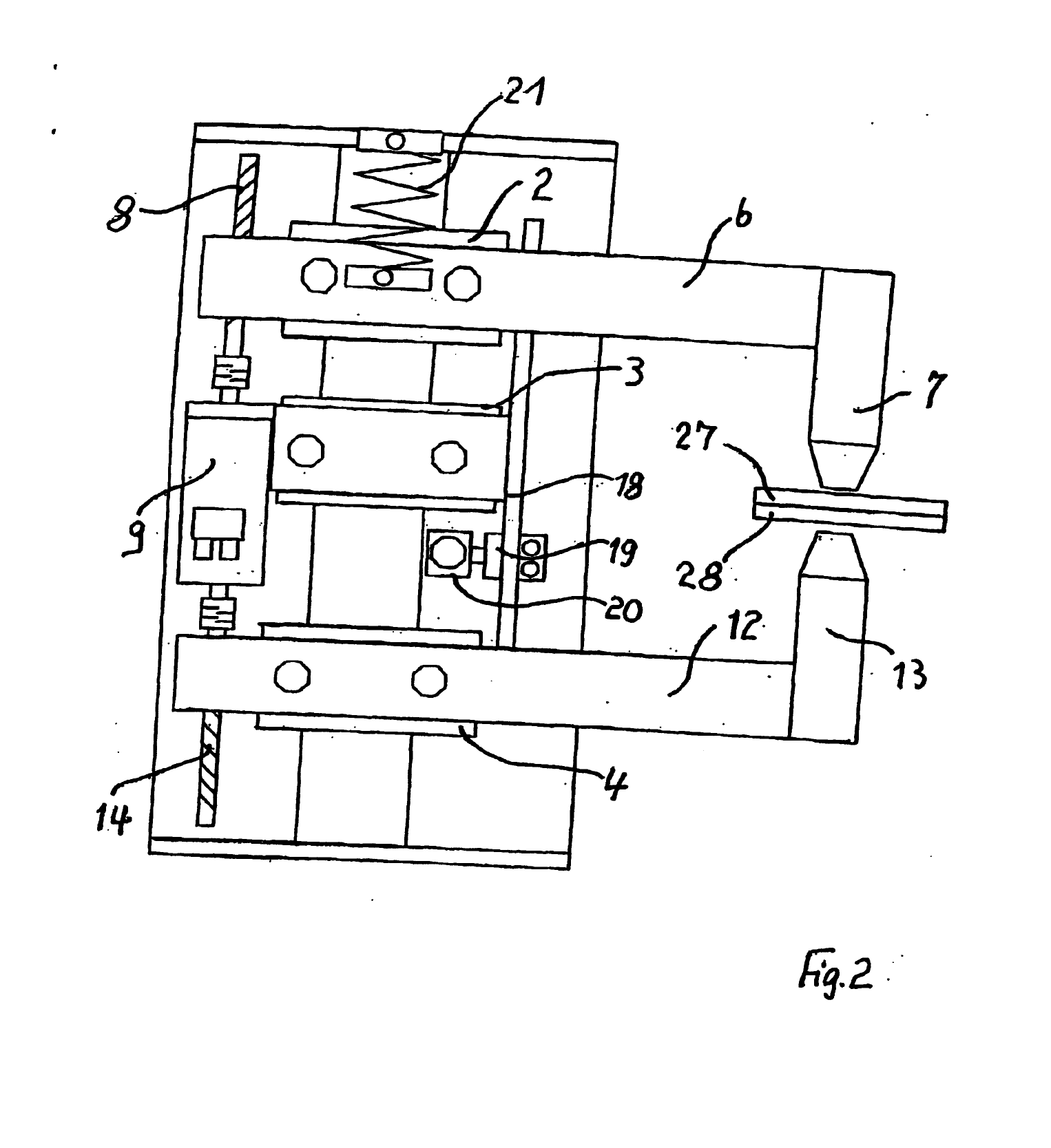

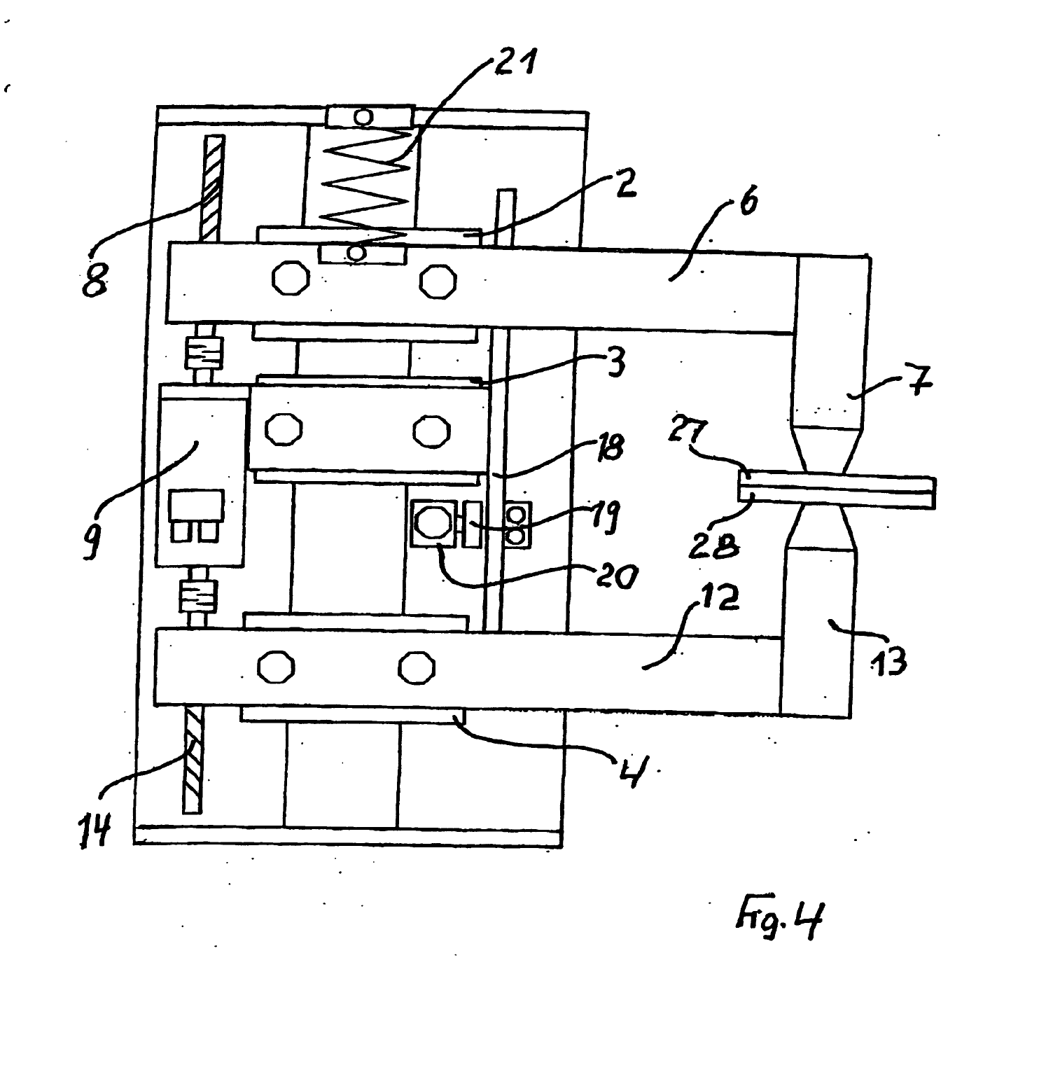

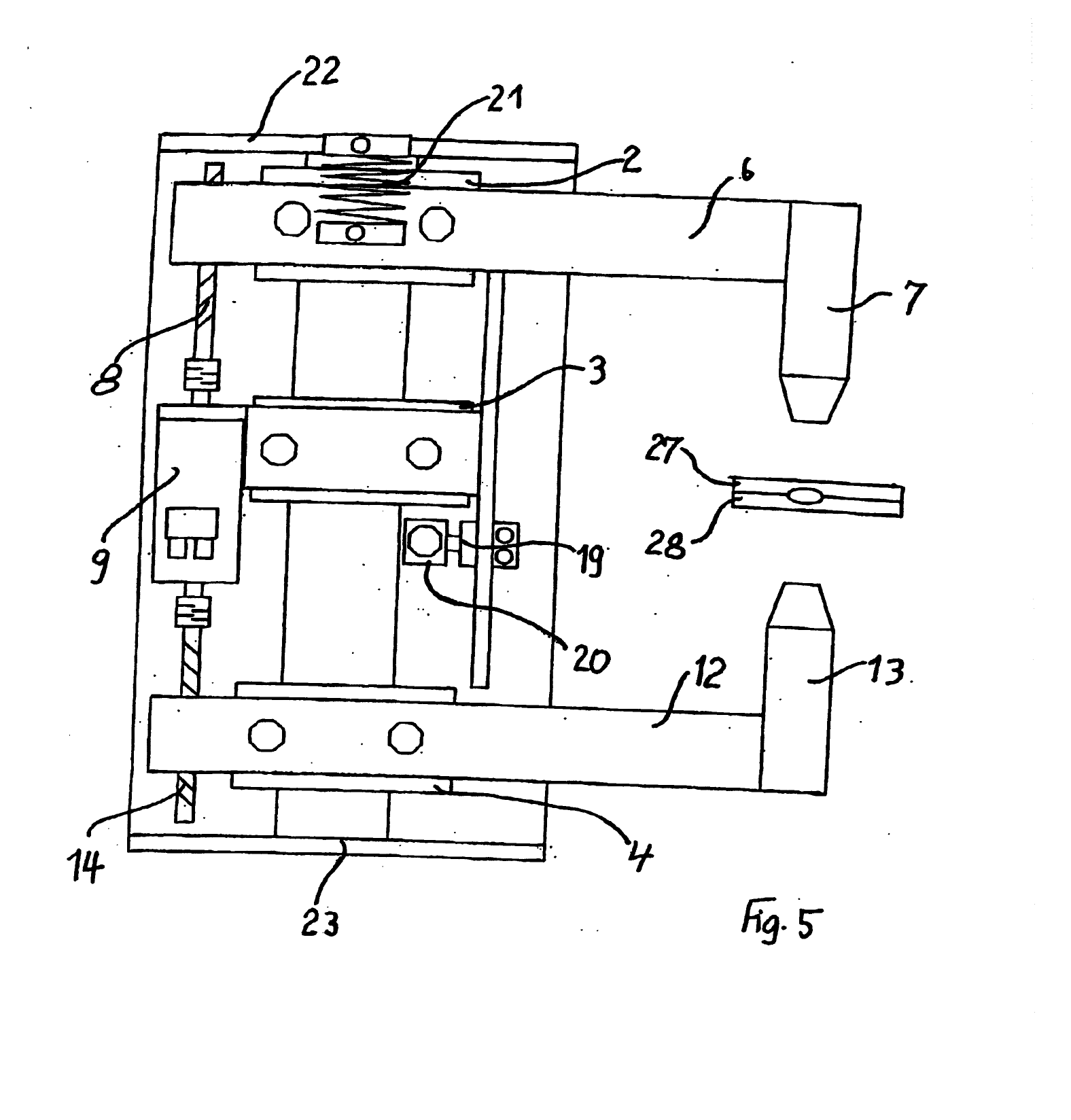

With the brake 20 applied, the welding apparatus is transferred into the region of two metal sheets 27, 28 that are to be welded to one another, i.e. into the position illustrated in FIG. 1. As soon as it has reached the position illustrated in FIG. 2, i.e. as soon as one of the electrodes 7, 8 is in the immediate vicinity of the sheet-metal assembly 27, 28, the brake 20 is released with the aid of a programmable logic controller (not described in more detail here), and as illustrated in FIG. 2 the upper electrode 7 is placed on the metal sheet 27. The servomotor 9 continues to run and “pulls” the lower electrode 13 upward while the upper electrode 7 is supported on the metal sheet 27, which to a certain extent forms a fixed point. In other words, the asymmetric position of the electrodes 7, 13 with respect to the sheet-metal assembly 27, 28 is automatically compensated for. This compensation prevents the metal sheets 27, 28 from being deformed or displaced. As soon as the closure movement of the electrodes 7, 13 has ended and the position shown in FIG. 4 has been reached, the welding operation takes place, during which the contact pressure of the electrodes 7, 13 and the welding time are controlled by sensors (not shown) acting on the servomotor 9. After the welding operation has ended, the brake 20 is actuated again, so that the two electrodes 7, 13 can move uniformly away from the metal sheets 27, 28 until they have reached the position illustrated in FIG. 5. If the position reached does not correspond to the central position, with the brake 20 open the servomotor 9 is switched on and the electrode carriers 6, 12 move away from one another until the upper carriage 2 for example comes to bear against the end stop 22 by means of the electrode carrier 6. From this moment on, the servomotor, as it continues to run, presses downward, with the lower carriage 2 with the electrode carrier 6 at the same time also moving downward relative to the servomotor 20 until it comes into contact with the end stop 23. This point in time is recorded by a force sensor (not shown), which switches off the servomotor 20. The electrode carriers 6, 12 are now in their desired starting position.

1. A welding apparatus with two electrode carriers which can be moved relative to one another by a drive unit, can be mounted with electrodes and together with the drive unit form an assembly which is mounted in a floating position on at least one linear guide (1), characterized in that the assembly is held in a base postion, from which the electrode carriers (6, 12) can be transferred to the welding position, by means for compensating for its weight, the drive unit being formed by a servomotor (9), which can be used to drive two spindles (8, 14) which are provided with opposing screw threads, are arranged parallel to the linear guide and engage with nuts assigned to the electrode carriers (6, 12).

2. The welding apparatus as claimed in claim 1, characterized in that it is equipped with a brake (20), by which the assembly formed by the electrode carriers (6, 12) and the servomotor (9) can be locked on the linear guide (1).

3. The welding apparatus as claimed in claim 2, characterized in that three carriages (2, 3, 4) are mounted on the linear guide (1).

4. The welding apparatus as claimed in claim 3, characterized in that the carriage (3) connected to the servomotor (9) can be locked by the brake (20).

5. The welding apparatus as claimed in claim 4, characterized in that a brake rail (18), which can be locked by a piston (19) of the brake (20), is connected to the carriage (3) carrying the servomotor (9).

6. The welding apparatus as claimed in claim 1, characterized in that the servomotor (9) is arranged between the electrode carriers (6, 12).

7. The welding apparatus as claimed in claim 1, characterized in that the spindles (8, 14) are connected, via clutches (10, 15), to opposite shaft stubs (11, 16) of the shaft of the servomotor (9).

8. The welding apparatus as claimed in claim 7, characterized in that the clutches (10, 15) are designed as slipping clutches.

9. The welding apparatus as claimed in claim 1, characterized in that the spindles (8, 14), which can be driven by the servomotor (9), engage with nuts at those ends of the electrode carriers (8, 12) which are remote from the electrodes (7, 13).

10. The welding apparatus as claimed in claim 1, characterized in that the means for compensating for its weight are formed by at least one spring (21).

11. The welding apparatus as claimed in claim 1, characterized in that the means for compensating for its weight are formed by a pneumatic cylinder.

12. The welding apparatus as claimed in claim 1, characterized in that the linear guide (1) is provided with end stops (22, 23).

13. The welding apparatus as claimed in claim 1, characterized in that three carriages (2, 3, 4) are mounted on the linear guide (1).

14. The welding apparatus as claimed in claim 2, characterized in that the servomotor (9) is arranged between the electrode carriers (6, 12).

15. The welding apparatus as claimed in claim 3, characterized in that the servomotor (9) is arranged between the electrode carriers (6, 12).

16. The welding apparatus as claimed in claim 2, characterized in that the spindles (8, 14) are connected, via clutches (10, 15), to opposite shaft stubs (11, 16) of the shaft of the servomotor (9).

17. The welding apparatus as claimed in claim 2, characterized in that the spindles (8, 14), which can be driven by the servomotor (9), engage with nuts at those ends of the electrode carriers (8, 12) which are remote from the electrodes (7, 13).

18. The welding apparatus as claimed in claim 2, characterized in that the means for compensating for its weight are formed by at least one spring (21).

19. The welding apparatus as claimed in claim 2, characterized in that the means for compensating for its weight are formed by a pneumatic cylinder.

20. The welding apparatus as claimed in claim 2, characterized in that the linear guide (1) is provided with end stops (22, 23).
